(19) United States
(12) Patent Application Publication
(10) Pub. No.: US 2014/0252890 A1
(43) Pub. Date: Sep. 11, 2014

(54) VIBRATION GENERATION DEVICE

(71) Applicant: CRESYN CO., LTD., Seoul (KR)

(72) Inventor: Jong-Bae LEE, Seoul (KR)

(73) Assignee: Cresyn Co., Ltd., Seoul (KR)

(21) Appl. No.: 13/790,702

(22) Filed: Mar. 8, 2013

(51) Int. Cl. H02K 33/00

(52) U.S. Cl. CPC H02K 33/00
USPC 310/25

(57) ABSTRACT

A vibration generation device is provided. The device includes a casing configured to have a receiving space in the casing, a coil received in a receiving space of the casing and configured to have an externally supplied current flow through the coil, a vibrator received in the receiving space of the casing, configured to comprise a magnet and a yoke surrounding the magnet, and disposed over the coil so that the vibrator is vibrated under an influence of a magnetic field through an interaction with the coil, and an elastic member received in the receiving space of the casing, disposed under the vibrator, and configured to elastically support the vibrator. There are advantages in that biased vibration can be improved because the elastic member and the yoke can be fixed at several places, a sufficient space where the elastic member can be vibrated can be secured because the elastic member is configured under the magnetic circuit.

### BACKGROUND OF THE INVENTION

1. Field of the Invention

The present invention relates to a vibration generation device.

2. Description of the Related Art

In general, a method of generating a ring tone or vibrating a communication device by shaking the communication device is being used as a method of informing an incoming call in the communication device. The method using vibration is chiefly used when other people are desired not to be damaged by a ring tone. To this end, a small-sized vibration generation device configured within a device is driven so that driving force is transferred to the casing of the device.

A vibration generation device applied to a communication device, such as a mobile phone, is a part for converting electrical energy into mechanical vibration by using a principle that electromagnetic force is generated. The vibration generation device is mounted on a mobile phone and used to inform an incoming call in a silence state.

As the mobile phone market is recently rapidly expanded and several functions are added to a mobile phone, the size of the elements of the mobile phone, such as the vibration generation device, needs to be reduced and the quality of the elements need to be improved. Accordingly, it is necessary to solve problems inherent in the existing problems and to provide further improved quality.

FIG. 1 is a cross-sectional view of a vibration generation device according to the related art.

As shown in FIG. 1, a conventional vibration generation device 10 includes a casing 11 (11-a and 11b) configured to include a receiving space, a lower plate 16 mounted on a lower part, a magnet 17 mounted on the lower plate 16 vertically to the lower plate 16, a yoke 18 mounted on the magnet 17 and configured to form a magnetic circuit along with the lower plate 16 and the magnet 17, an elastic member 15 mounted between the casing 11 and the yoke 18 and configured to vibrate a vibrator, including a weight 19 mounted on the yoke 18, up and down, and a vibration generation coil 14 provided in the upper part of a bracket for sealing the bottom of the casing 11.

In this vibration generation device 10, the elastic member 15 is disposed between the inner surface of the casing 11 and the outer surface of the yoke 18, that is, the vibrator, so that vibration generated from the vibrator is transferred to the casing 11. In this vibration generation device 10, however, left or right biased vibration is generated when the vibrator is vibrated up and down because a specific space is formed between the inner surface of the casing 11 and the outer surface of the yoke 18.

Korean Patent Registration No. 10-0593917 entitled Vertical Vibrator discloses technology in which a damping member for absorbing an impact due to a contact between the casing and a vibrating body is configured in the space formed between the inner surface of the casing and the outer surface of the vibrating body.

In the above technology, however, welding is performed on the yoke when fixing the elastic member and the vibrating body. Furthermore, a point on which welding is performed when fixing the elastic member to the outer surface of the yoke basically corresponds to the center point of the yoke.

The above technology is problematic in that it is difficult to reduce the occurrence of biased vibration because the point at which the elastic member and the vibrating body are welded together corresponds to one point of the central part within the yoke. Furthermore, there is a problem in that the damping member functions as only a shock-absorbing member, but cannot become a fundamental solution for stabilizing the up and down vibration of the vibrating body itself in a stable state.

Furthermore, there are problems in that a lower space where a magnetic circuit is configured is limited because the elastic member is adhered to the upper part of the casing and thus a vibration width is reduced.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide technology in which biased vibration occurring when the vibrating body of a vibration generation device is vibrated up and down can be reduced.

In accordance with an aspect of the present invention, a vibration generation device is provided. The device includes a casing configured to have a receiving space in the casing, a coil received in the receiving space of the casing and configured to have an externally supplied current flow through the coil, a vibrator received in the receiving space of the casing, configured to include a magnet and a yoke surrounding the magnet, and disposed over the coil so that the vibrator is vibrated under the influence of a magnetic field through an interaction with the coil, and an elastic member received in the receiving space of the casing, disposed under the vibrator, and configured to elastically support the vibrator.

Furthermore, the elastic member includes a sheet spring configured to have a central part perforated so that the coil can pass through the central part.

Here, the inner edge of the sheet spring is fixed to the yoke of the vibrator.

Furthermore, a plurality of points is welded to portions where the inner edge of the sheet spring comes into contact with the yoke.

Meanwhile, the outer edge of the sheet spring is fixed to the casing.

Furthermore, fixing protrusions are formed in the outer edge of the sheet spring, insertion portions corresponding to the respective fixing protrusions are formed in the casing, and the fixing protrusions are inserted into the insertion portions so that the sheet spring is fixed to the casing.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a cross-sectional view of a vibration generation device according to the related art;

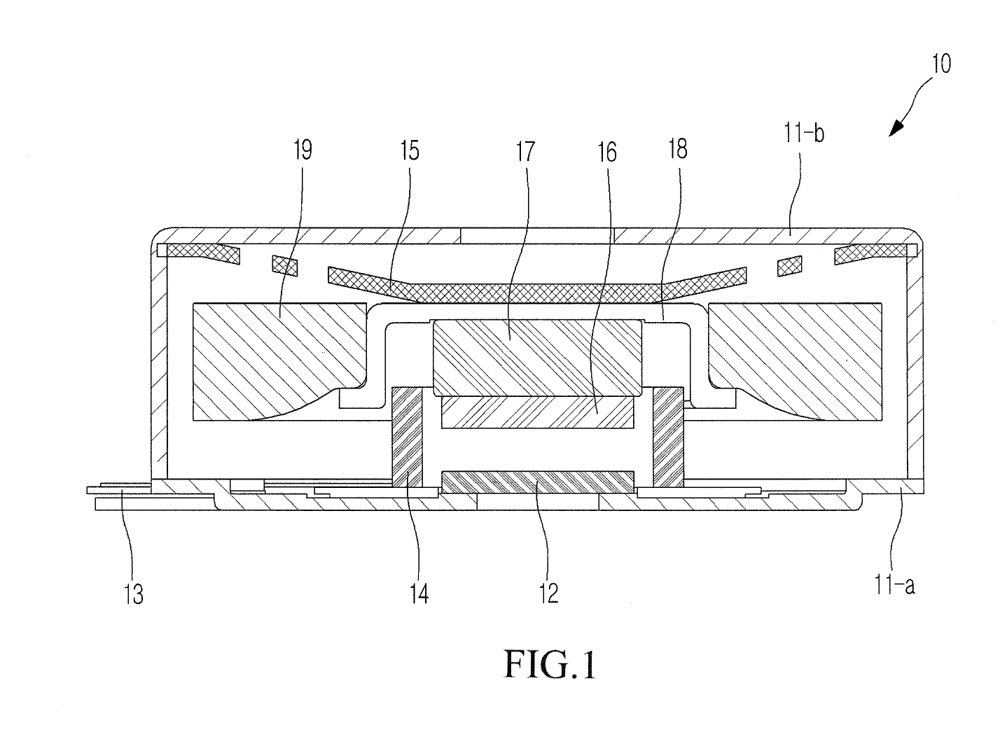

FIG. 2 is an exploded perspective view of a vibration generation device according to an exemplary embodiment of the present invention; and

FIG. 3 is a cross-sectional view of the vibration generation device according to an exemplary embodiment of the present invention.

Throughout the drawings, it should be noted that like reference numbers are used to depict the same or similar elements, features, and structures.

DESCRIPTION OF REFERENCE NUMERALS OF
PRINCIPAL ELEMENTS IN THE DRAWINGS

| | |
|---|---|
| 100: vibration generation device | |
| 110: casing | 120: stopper |

| | |
|---|---|
| 130: FPCB | 140: coil |

| | |
|---|---|
| 150: sheet spring | |
| 152: inner edge | 154: outer edge |
| 160: plate | 170: magnet |
| 180: yoke | 190: weight |

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

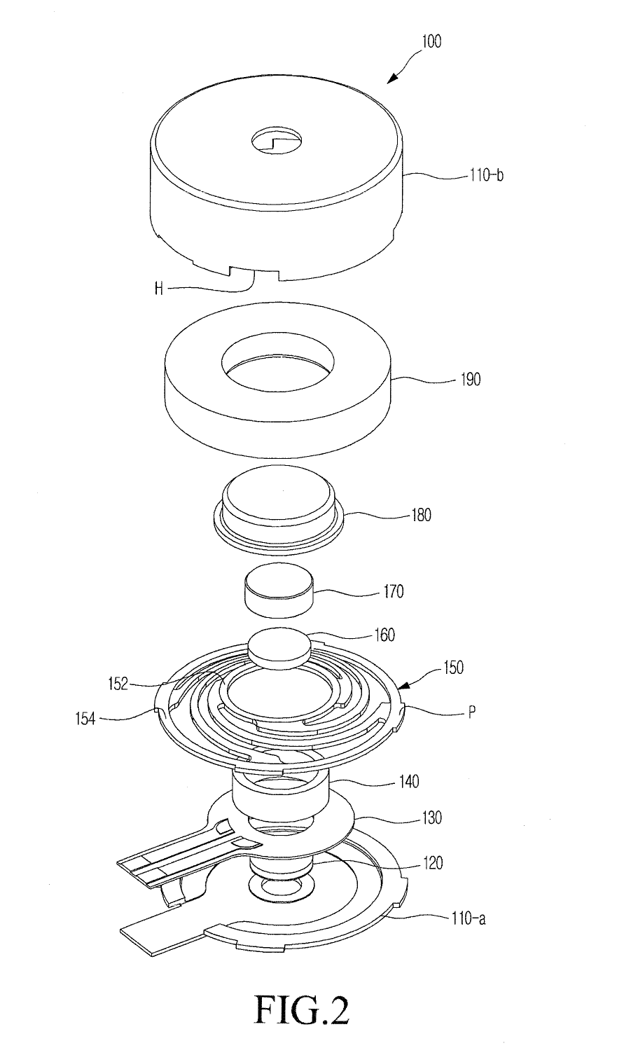

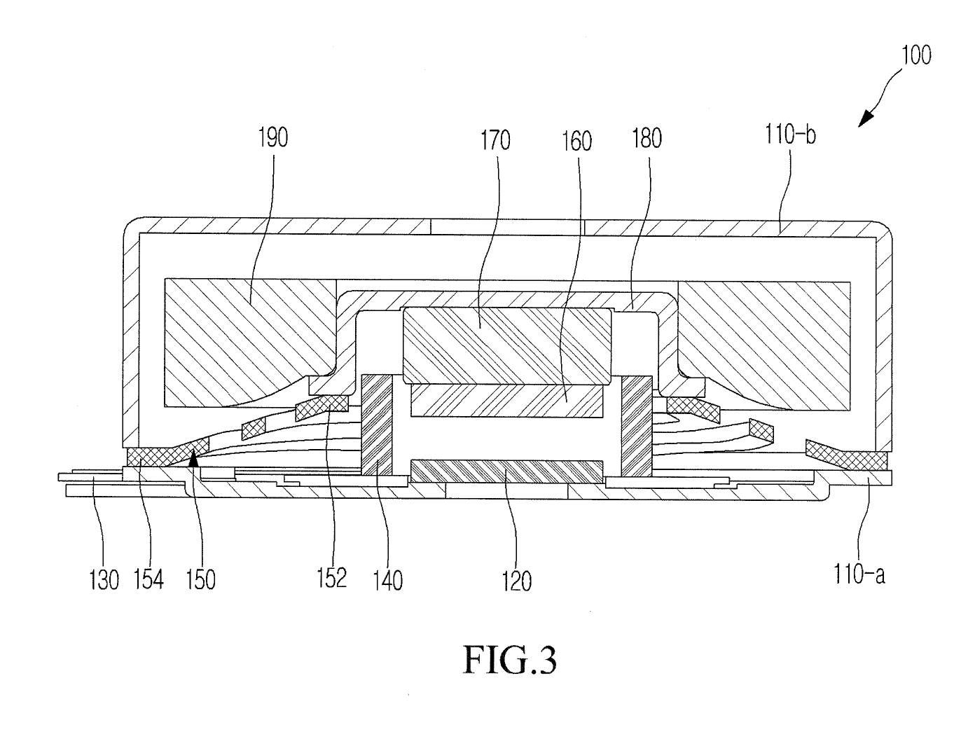

FIG. 2 is an exploded perspective view of a vibration generation device according to an exemplary embodiment of the present invention and FIG. 3 is a cross-sectional view of the vibration generation device according to an exemplary embodiment of the present invention.

Referring to FIGS. 2 and 3, the vibration generation device 100 in accordance with an exemplary embodiment of the present invention includes a lower casing 110-a, a stopper 120, a Flexible Printed Circuit Board (FPCB) 130, a coil 140, a sheet spring 150, a plate 160, a magnet 170, a yoke 180, a weight 190, and an upper casing 110-b.

The lower casing 110-a forms one casing 110 having a receiving space along with the upper casing 110-b. The lower casing 110-a is configured to have the stopper 120, the FPCB 130, the coil 140, and the sheet spring 150 adhered or fixed thereto.

Furthermore, in an exemplary embodiment of the present invention, the sheet spring 150 is fixed to the lower casing 110-a so that the magnet 170, the yoke 180 and the weight 190 which vibrate up and down are elastically supported.

The stopper 120 is configured to prevent the up and down vibration of the magnet 170, the yoke 180, and the weight 190 from exceeding a specific range and also configured to prevent the plate 160 adhered to the magnet 170 from giving an impact to the FPCB 130 due to the up and down vibration. Furthermore, the stopper 120 prevents unnecessary up and down vibration, thereby being capable of increasing the lifespan of the sheet spring 150.

The Flexible Printed Circuit Board (FPCB) 130 is a circular plate coated with a thin and flexible copper film, and the FPCB 130 functions to supply a power source to the coil 140 so that a current can flows through the coil 140.

A current supplied through the FPCB 130 flows the coil 140. The coil 140 is spaced apart from the magnet 170 at a specific interval and configured to form a magnetic field through an interaction with the magnet 170.

The coil 140 may be made of copper (Cu) or aluminum (Al) and may be configured to implement up and down vibration in an optimal state depending on a material and shape and the diameter and insulating material of the coil 140.

Referring to FIG. 2, the sheet spring 150 is disposed under the plate 160, the magnet 170, the yoke 180, and the weight 190 which are vibrated up and down through an interaction with the coil 140 and configured to elastically support the plate 160, the magnet 170, the yoke 180, and the weight 190.

The sheet spring 150 is configured to have a form in which a central part thereof through which the coil 140 can pass is perforated. The sheet spring 150 is configured to have an inner edge 152 fixed to the yoke 180 and an outer edge 154 fixed to the lower casing 110-a. Furthermore, the sheet spring 150 can be welded to the lower casing 110-a and the yoke 180 by using a method, such as bonding or welding.

That is, since the inner edge 152 of the sheet spring 150 is fixed along the periphery of the yoke 180 opened to surround the magnet 170, a point at which the sheet spring 150 is welded for the fixing is not concentrated at one place, but a plurality of points of the sheet spring 150 can be welded to a portion where the sheet spring 150 comes into contact with the yoke 180. Accordingly, the sheet spring 150 can be configured to achieve stability against the up and down vibration of the magnet 170, the yoke 180, and the weight 190.

Furthermore, the outer edge 154 of the sheet spring 150 is configured to be fixed to the casing 110. Fixing protrusions P are formed at the outer edge 154 of the sheet spring 150. Accordingly, the fixing protrusions P can be inserted into respective insertion portions H formed in the casing 110 so that the sheet spring 150 is fixed to the casing 110.

Meanwhile, the plate 160, the magnet 170, the yoke 180, and the weight 190 are configured to be disposed over the coil 140 so that they are received in the receiving space of the casing 110 and vibrated under the influence of the magnetic field through an interaction with the coil 140.

The plate 160 is adhered to the opened surface of the magnet 170 that is not surrounded by the yoke 180 and may be configured to have a shape corresponding to that of the magnet 170. The plate 160 is configured such that the magnetic field from the yoke 180 passes through the coil 140 and then circulates from the lower part to the upper part of the magnet 170 via the inside of the plate 160.

Meanwhile, the plate 160 may be made of pure iron, the coil 140 and the plate 160 are spaced apart from each other at a specific interval, and the plate 160 may be implemented to optimize the generation of the magnetic field for up and down vibration depending on the interval between the coil 140 and the plate 160 and a thickness thereof.

The magnet 170 is disposed within the yoke 180 and fixed thereto and configured to form the magnetic field through an interaction with the coil 140. The magnet 170 is configured such that the formed magnetic field is circulated by the yoke 180 and the plate 160, thus passing through the coil 140.

The yoke 180 is configured to control a flow of the magnetic field generated from the magnet 170 so that the intensity of the magnetic field is maximized and thus the magnetic field passes through the coil 140 and moves to the plate 160.

The yoke 180 may be made of pure iron. If the degree of purity of pure iron is higher, the magnetic field can implement a better up and down vibration state without distortion. Furthermore, the opened portion of the yoke 180 that faces toward the magnetic circuit is configured to have an outwardly bend shape. Accordingly, biased vibration can be improved because a portion at which the sheet spring 150 is fixed can be more moved to the outside than the center.

The sheet spring 150 and the yoke 180 may be fixed together by using laser welding. The laser welding is a welding method of melting metal using a laser and attaching the molten metal. The plurality of points where the sheet spring 150 comes into contact with the yoke 180 are welded and fixed.

That is, biased vibration can be reduced because stable up and down vibration can be achieved as compared with the existing method of welding one point at the center of the inside of the yoke 180.

The weight 190 is adhered to the yoke 180 in such a way as to surround the circumference of the yoke 180 and configured to apply proper weight for vibration to the yoke 180. The weight 190 may be made of a material having heavier specific gravity than iron and may be made of tungsten (W). In some exemplary embodiments, the weight 190 may be made of a non-magnetic material.

Accordingly, since mass can be increased by using the weight 190 within the same volume, the amount of vibration can be maximized by controlling a resonant frequency that is related to mass of the plate 160, the magnet 170, and the yoke 180.

The upper casing 110-b is configured to protect parts received therein in combination with the lower casing 110-a. Here, the upper casing 110-b may be configured to have a sufficient space so that it does not come into contact with the lower casing 110-a owing to the up and down movement of the magnet 170, the yoke 180, and the weight 190.

The upper casing 110-b is configured to include the insertion portions H into which the fixing protrusions P formed in the outer edge 154 of the sheet spring 150 can be inserted. Accordingly, the upper casing 110-b prevents the sheet spring 150 from rotating in a manufacturing process, thereby being capable of reducing the occurrence of a failure due to the rotation of the sheet spring 150.

Meanwhile, in the vibration generation device 100 according to an exemplary embodiment of the present invention, all the elements, including the sheet spring 150, the plate 160, the magnet 170, the yoke 180, and the weight 190, are provided over the lower casing 110-a. Accordingly, work convenience can be achieved in a manufacturing process for producing a product, a failure state can be reliably checked even in the state in which the upper casing 110-b has not been adhered to the lower casing 110-a, and a work process can be simplified.

As described above, the present invention can have the following advantages.

First, there is an advantage in that biased vibration can be improved because the elastic member and the yoke can be fixed at several places.

Second, there is an advantage in that a sufficient space where the elastic member can be vibrated can be secured because the elastic member is configured under the magnetic circuit.

Third, there are advantages in that work convenience for product fabrication can be improved and a failure state can be easily checked because all the elements including the magnetic circuit are disposed on the lower side.

Fourth, there are advantages in that an assembly process can be reduced because the elastic member is configured on the lower side and a failure due to the rotation of the elastic member can be reduced because the degree of rotation of the elastic member can be controlled in an assembly process.

Fifth, there is an advantage in that a contact with other surrounding members due to biased vibration can be prevented because stability against the up and down movement of the vibrator is improved.

Sixth, there are advantages in that noise occurring due to a contact with surrounding members can be prevented and efficient of vibration can be improved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A vibration generation device, the device comprising:
a casing configured to have a receiving space in the casing;
a coil received in the receiving space of the casing and configured to have an externally supplied current flow through the coil;
a vibrator received in the receiving space of the casing, configured to comprise a magnet and a yoke surrounding the magnet, and disposed over the coil so that the vibrator is vibrated under an influence of a magnetic field through an interaction with the coil; and
an elastic member received in the receiving space of the casing, disposed under the vibrator, and configured to elastically support the vibrator.

2. The device of claim 1, wherein the elastic member comprises a sheet spring configured to have a central part perforated so that the coil can pass through the central part.

3. The device of claim 2, wherein an inner edge of the sheet spring is fixed to the yoke of the vibrator.

4. The device of claim 2, wherein a plurality of points is welded to portions where an inner edge of the sheet spring comes into contact with the yoke.

5. The device of claim 2, wherein an outer edge of the sheet spring is fixed to the casing.

6. The device of claim 5, wherein:
fixing protrusions are formed in the outer edge of the sheet spring,
insertion portions corresponding to the respective fixing protrusions are formed in the casing, and
the fixing protrusions are inserted into the insertion portions so that the sheet spring is fixed to the casing.
